(19) United States
(12) Patent Application Publication
(10) Pub. No.: US 2017/0139232 A1
(43) Pub. Date: May 18, 2017

(54) COLORED CONTACT LENS

(71) Applicant: HON HAI PRECISION INDUSTRY CO., LTD., New Taipei (TW)

(72) Inventor: HSIU-WEN CHIEN, New Taipei (TW)

(21) Appl. No.: 14/957,900

(22) Filed: Dec. 3, 2015

(30) Foreign Application Priority Data
Nov. 13, 2015 (TW) 104137636

(51) Int. Cl. G02C 7/04; C09K 11/77; C09K 11/65; C09K 11/60; C09K 11/66; C09K 11/59; G02C 11/04; C09K 11/61

(52) U.S. Cl. CPC G02C 7/046; G02C 7/049; G02C 11/04; C09K 11/7701; C09K 11/7706; C09K 11/61; C09K 11/602; C09K 11/661; C09K 11/59; C09K 11/65

(57) ABSTRACT

A colored contact lens includes an iris region made of a first mixed liquid, and the first mixed liquid includes a colored material and a contact lens material. The colored material absorbs and stores light when in a well lit environment and emits lights when in a poorly lit environment or a dark environment. Therefore, when the colored contact lens is located in a well lit environment, light is absorbed and stored, and when the contact lens is in a poorly lit environment or the dark environment light is emitted.

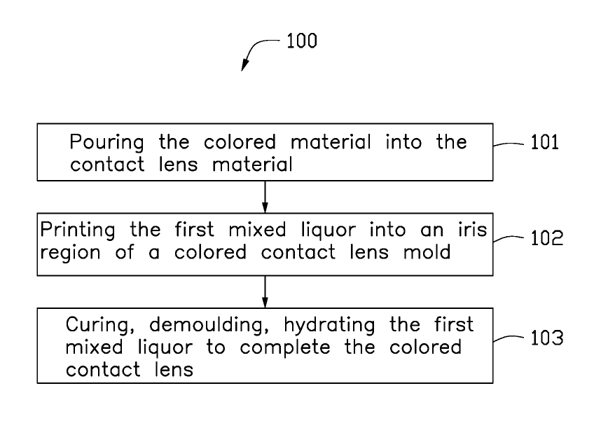

### FIELD

The subject matter herein generally relates to a color contact lens.

### BACKGROUND

It has been known that a colored contact lens is useful for softening light to protect the eye. In general, a colored contact lens is often used for cosmetic purposes to change the color of an eye. For example, brown or blue eyes can become green with the person wearing colored contact lenses.

### BRIEF DESCRIPTION OF THE DRAWINGS

Implementations of the present technology will now be described, by way of example only, with reference to the attached figures.

The FIGURE is a flowchart of an example embodiment for making a color contact lens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that apply throughout this disclosure will now be presented.

The term “comprising,” when utilized, means “including, but not necessarily limited to”; it specifically indicates open-ended inclusion or membership in the so-described combination, group, series, and the like.

The present disclosure is described in relation to a colored contact lens. A colored contact lens includes an iris region made of a first mixed liquid, and the first mixed liquid includes a colored material and a contact lens material. The colored material absorbs and stores light when in a well lit environment and emits light when in a poorly lit environment or a dark environment. Therefore, the colored contact lens is configured to absorb and store light when located in a well lit environment, and the contact lens is configured to emit light when in a poorly lit environment or dark environment.

The color contact lens can be made by contact lens molding, such as injection molding or die. Injection molding is often used for short use or medical use contact lenses. A quantitative liquid monomer is injected in a rotary die molding that has a predetermined rotation speed, and the liquid monomer can form a thin film under the centrifugal force of high speed rotation. A curvature of the color contact can be determined by the mold shape and mold speed. When a color contact lens is strong, the color contact lens can be used for a long time.

In at least one embodiment, a first mixed liquid comprising colored material and contact lens material can be printed into an iris region of a colored contact lens mold, and the colored contact lens can be made via curing, demolding, hydration. When the colored contact lens is located in a well lit environment, the colored contact lens can absorb and store light, and when the contact lens is in a poorly lit environment or a dark environment, the contact lens can emit light. In at least one embodiment, the contact lens can emit phosphorescent light.

In at least one embodiment, the colored material can be luminescent material, such as rare earth activated sulfide, rare earth activated alkaline earth aluminates, rare earth activated silicate, calcium fluoride (CaF₂), ferric oxide (Fe₂O₃), lead oxide (PbO), silicon dioxide (SiO2), sodium carbonate (Na₂CO₃), calcium carbonate (CaCO₃), or a second mixed liquid including at least two compounds of the rare earth activated alkaline earth aluminates, rare earth activated silicate, CaF₂, Fe₂O₃, PbO, SiO2, Na₂CO₃, CaCO₃.

In at least one embodiment, the contact lens material can be a third mixed liquid including a hydrophilic monomer, cross-linking agent and initiator. The hydrophilic monomer can be 2-Hydroxyethyl methacrylate (HEMA), glycidyl methacrylate (GMA), vinyl pyrrolidone (NVP), methylacrylic acid (MAA), Dimethyl Acetamide (DMA), or silicone based monomer. The cross-linking agent can be Ethyleneglycol dimethacrylate (EGDMA) or Trimethylolpropane trimethacrylate (TMPTMA). The initiator can be 2,2-Azobis isobutyronitrile (AIBN) or Irgacure-1173.

In at least one embodiment, a percentage of contact lens materials in the first mixed liquid is 24%-78%, and a percentage of colored material in the first mixed liquid is 17%-65%. In addition, a percentage of the hydrophilic monomer in the third mixed liquid is 42%-78%, a percentage of the cross-linking agent in the third mixed liquid is 10%-38%, and a percentage of the initiator in the third mixed liquid is 1%-8%.

The FIGURE illustrates a flowchart in accordance with an example embodiment. The example method 100 is provided by way of example, as there are a variety of ways to carry out the method. Each block shown in the FIGURE represents one or more processes, methods, or subroutines, carried out in the exemplary method 100. Additionally, the illustrated order of blocks is by example only and the order of the blocks can change. The exemplary method 100 can begin at block 101.

At block 101, the first mixed liquid is made by pouring the colored material into the contact lens material.

At block 102, the first mixed liquid is printed into an iris region of a colored contact lens mold. In at least one embodiment, the color of the colored contact lens can be changed by the temperature and the ratio of the first mixed liquid.

At block 103 the first mixed liquid is cured, removed from the mold, and hydrated to complete the colored contact lens.

When the colored contact lens is located in a well lit environment, the colored contact lens can absorb and store light, and when the contact lens is in a poorly lit environment or a dark environment, the contact lens can emit light. In at least one embodiment, the contact lens can emit phosphorescent light.

The embodiments shown and described above are only examples. Many details are often found in the art such as the other features of a standard working hours management system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. A colored contact lens comprising:
an iris region made of a first mixed liquid, the first mixed liquid comprising a colored material and a contact lens material, the colored material absorbing and storing light when the colored contact lens is located in a well lit environment, and emitting light when the colored contact lens is located in an poorly lit environment or a dark environment;
wherein when the colored contact lens is located in the well lit environment, the colored contact lens absorbs and stores light, and when the colored contact lens is in the poorly lit environment or the dark environment, the contact lens emits light;
wherein the contact lens material comprises a hydrophilic monomer, a cross-linking agent, and an initiator, the hydrophilic monomer is selected from a group consisting of vinyl pyrrolidone (NVP), methylacrylic acid (MAA), dimethyl Acetamide (DMA), and a silicone based monomer, the cross-linking agent is selected from a group consisting of ethyleneglycol dimethacrylate (EGDMA) and trimethylolpropane trimethacrylate (TMPTMA), and the initiator is selected from a group consisting of 2,2-Azobisisobutyronitrile (AIBN) and Irgacure-1173.

2. The colored contact lens of claim 1, wherein the colored contact lens is configured to emit phosphorescent light.

3. The colored contact lens of claim 1, wherein a percentage of the colored material in the first mixed liquid is from 17% to 65%.

4. The colored contact lens of claim 1, wherein a percentage of contact lens materials in the first mixed liquid is from 24% to 78%.

5. The colored contact lens of claim 1, wherein the colored material is luminescent material, and the luminescent material is selected from a group consisting of rare earth activated sulfide, rare earth activated alkaline earth aluminates, rare earth activated silicate, calcium fluoride (CaF₂), ferric oxide (Fe₂O₃), lead oxide (PbO), silicon dioxide (SiO₂), sodium carbonate (Na₂CO₃), calcium carbonate (CaCO₃), or any combination thereof.

6. (canceled)

7. The colored contact lens of claim 1, wherein a percentage of the hydrophilic monomer in the contact lens material is from 42% to 78%, a percentage of the cross-linking agent in the contact lens material is from 10% to 38%, and a percentage of the initiator in the contact lens material is from 1% to 8%.

8. A colored contact lens comprising:
an iris region made of a first mixed liquid, the first mixed liquid comprising a colored material and a contact lens material, the colored material absorbing and storing light when the colored contact lens is located in a well lit environment, and emitting light when the colored contact lens is located in a poorly lit environment or a dark environment;
wherein a percentage of the colored material in the first mixed liquid is from 17% to 65%, and a percentage of contact lens material in the first mixed liquid is from 24% to 78%;
wherein the contact lens material comprises a hydrophilic monomer, a cross-linking agent, and an initiator, the hydrophilic monomer is selected from a group consisting of vinyl pyrrolidone (NVP), methylacrylic acid (MAA), dimethyl acetamide (DMA), and a silicone based monomer, the cross-linking agent is selected from a group consisting of ethyleneglycol dimethacrylate (EGDMA) and trimethylolpropane trimethacrylate (TMPTMA), and the initiator is selected from a group consisting of 2,2-Azobisisobutyronitrile (AIBN) and Irgacure-1173.

9. The colored contact lens of claim 8, wherein the colored contact lens is configured to emit phosphorescent lights.

10. The colored contact lens of claim 8, wherein the colored material is luminescent material, and the luminescent material is selected from a group consisting of rare earth activated sulfide, rare earth activated alkaline earth aluminates, rare earth activated silicate, calcium fluoride (CaF₂), ferric oxide (Fe₂O₃), lead oxide (PbO), silicon dioxide (SiO₂), sodium carbonate (Na₂CO₃), calcium carbonate (CaCO₃), or any combination thereof.

11. (canceled)

12. The colored contact lens of claim 8, wherein a percentage of the hydrophilic monomer in the contact lens material is from 42% to 78%, a percentage of the cross-linking agent in the contact lens material is from 10% to 38%, and a percentage of the initiator in the contact lens material third mixed liquid is from 1% to 8%.
